(19) United States
(12) Patent Application Publication
(10) Pub. No.: US 2019/0289186 A1
(43) Pub. Date: Sep. 19, 2019

(54) IMAGING DEVICE

(71) Applicants: Hisashi Saito, Aichi (JP); Yoshio Matsuura, Aichi (JP)

(72) Inventors: Hisashi Saito, Aichi (JP); Yoshio Matsuura, Aichi (JP)

(73) Assignees: OMRON AUTOMOTIVE ELECTRONICS CO., LTD., Aichi (JP); Omron Corporation, Kyoto (JP)

(21) Appl. No.: 16/352,677

(22) Filed: Mar. 13, 2019

(30) Foreign Application Priority Data
Mar. 13, 2018 (JP) 2018-045251

(51) Int. Cl. H04N 5/235; G06K 9/00; G06K 9/20; G06T 5/50

(52) U.S. Cl. CPC H04N 5/2352; H04N 5/2351; G06K 9/00228; G06K 9/00845; G06K 9/2027; G06T 2207/30268; G06T 5/50; G06T 2207/20224; G06T 2207/10152; G06T 2207/30201; G06K 9/2054

(57) ABSTRACT

An imaging device includes: an imaging unit that creates a first image of a subject captured with a light emitting element not emitting light and a second image of the subject captured with the light emitting element emitting light; an image processor that creates a difference image being difference between the first image and the second image, and detects the subject according to the difference image; a luminance detector that detects luminance of the first image and luminance of the difference image; a target luminance setting unit that sets target luminance of the difference image according to the luminance of the first image detected by the luminance detector; and a sensitivity adjusting unit that adjusts imaging sensitivity of the imaging unit such that the luminance of the difference image detected by the luminance detector approaches the target luminance set by the target luminance setting unit.

### CROSS-REFERENCE TO RELATED APPLICATION

This application is based on Japanese Patent Application No. 2018-045251 filed with the Japan Patent Office on Mar. 13, 2018, the entire contents of which are incorporated herein by reference.

### FIELD

The disclosure relates to an imaging device such as a driver monitor mounted on, for example, a vehicle, and in particular, to an imaging device emitting light to a subject and capturing an image of the subject.

### BACKGROUND

A driver monitor mounted on a vehicle is a device that analyzes an image of the driver's face captured by a camera and monitors the presence or absence of dozing driving and inattentive driving according to the eyelid closure degree, the sight line direction, and the like.

The camera of the driver monitor is provided with an imaging element capturing an image of the driver's face. However, it is difficult to accurately capture an image of the driver's face at night or in a tunnel because the interior of the vehicle is dark. Therefore, a light emitting element is provided in the camera, and the driver's face is irradiated with light emitted from the light emitting element upon image capturing. Thus, an image is captured in a state where the face is brightened.

As the light emitting element, for example, an LED that emits near-infrared light is used. In addition, as the imaging element, for example, a CMOS image sensor exhibiting high sensitivity characteristics in the near infrared region is used. By using such an imaging element and such a light emitting element, even in a case where a vehicle travels at night or in a tunnel, it is possible to capture an image of the driver's face with high sensitivity. Each of JP 2017-175199 A and JP 2009-276849 A describes a driver monitor that emits light to the driver's face and captures an image of the driver's face as described above.

In the driver monitor disclosed in JP 2017-175199 A, an image of the face captured in a state where light is not emitted (first image) and an image of the face captured in a state where light is emitted (second image) are obtained. Then, difference between luminance of the first image and luminance of the second image is calculated, and the face portion in an imaging range is determined according to the difference.

In the driver monitor of JP 2009-276849 A, image processing is performed on a wide area (face contour or the like) of the driver's face using a first captured image captured under a condition of low light exposure, and image processing is performed on a part (eyes or the like) of the driver's face using a second captured image captured under a condition of high exposure.

As in JP 2017-175199 A, by creating a difference image which is difference between the first image in the case of not emitting light and the second image in the case of emitting light, the influence of ambient light such as sunlight is removed and a clear face image with less luminance unevenness can be obtained.

However, ambient light entering the interior of a vehicle is not uniform and varies depending on the weather and surrounding environment. Therefore, in a case where the amount of ambient light is small, remarkable luminance difference appears between the first image and the second image. However, for example, in a state where sunlight hits the face and the face is bright enough, brightness of the face does not change very much whether or not light is emitted. Therefore, remarkable luminance difference does not appear between the first image and the second image. Therefore, if the difference between the first image and the second image is calculated in this case, the entire difference image becomes extremely dark and has so-called blocked-up shadows.

Therefore, the face cannot be accurately recognized in image processing.

### SUMMARY

An object of the disclosure is to provide an imaging device capable of adjusting a difference image to an optimum brightness according to the level of ambient light.

An imaging device according to one or more embodiments of the disclosure includes an imaging unit, an image processor, a luminance detector, a target luminance setting unit, and a sensitivity adjusting unit. The imaging unit includes: an imaging element configured to capture an image of a subject; and a light emitting element configured to emit light to the subject. The imaging unit creates a first image of the subject captured in a state where the light emitting element does not emit light and a second image of the subject captured in a state where the light emitting element emits light. The image processor creates a difference image which is difference between the first image and the second image, and detects the subject according to the difference image. The luminance detector detects luminance of the first image and luminance of the difference image. The target luminance setting unit sets target luminance of the difference image according to the luminance of the first image detected by the luminance detector. The sensitivity adjusting unit adjusts imaging sensitivity of the imaging unit such that the luminance of the difference image detected by the luminance detector approaches the target luminance set by the target luminance setting unit.

In the imaging device as described above, the luminance of the first image and the luminance of the difference image are detected, the target luminance of the difference image is set according to the luminance of the first image, and the imaging sensitivity of the imaging unit is adjusted such that the luminance of the difference image approaches the target luminance. Therefore, the level of ambient light can be determined from the luminance of the first image, and the target luminance of the difference image can be set to a value corresponding to the level of the ambient light. As a result, it is possible to adjust the difference image to optimal brightness by setting the target luminance to be low in a case where the amount of ambient light is great and by setting the target luminance to be high in a case where the amount of ambient light is small.

In one or more embodiments of the disclosure, the target luminance setting unit may compare the luminance of the first image detected by the luminance detector with a luminance threshold set in advance. In a case where the luminance of the first image is not greater than the luminance threshold, the target luminance of the difference image may be increased. In a case where the luminance of the first image is greater than the luminance threshold, the target luminance of the difference image may be reduced.

In one or more embodiments of the disclosure, the sensitivity adjusting unit may increase the imaging sensitivity in a case where the luminance of the difference image detected by the luminance detector is lower than the target luminance by a predetermined amount, and the sensitivity adjusting unit may decrease the imaging sensitivity in a case where the luminance of the difference image detected by the luminance detector exceeds the target luminance by a predetermined amount.

In one or more embodiments of the disclosure, the target luminance setting unit may have a first table storing ambient light levels at a plurality of stages according to the luminance of the first image and target luminance corresponding to each of the ambient light levels, and the target luminance setting unit may set, with reference to the first table, the target luminance for the luminance of the first image detected by the luminance detector.

In one or more embodiments of the disclosure, the sensitivity adjusting unit may have a second table storing sensitivity levels at a plurality of stages according to the imaging sensitivity of the imaging unit and sensitivity adjustment parameters corresponding to the sensitivity levels, respectively. The sensitivity adjusting unit may adjust the imaging sensitivity according to the sensitivity adjustment parameters with reference to the second table, with respect to the target luminance of the difference image set by the target luminance setting unit.

In one or more embodiments of the disclosure, the sensitivity adjustment parameters may include at least one of exposure time of the imaging element, a driving current of the light emitting element, and a gain of the imaging element.

In one or more embodiments of the disclosure, the sensitivity adjusting unit may adjust the imaging sensitivity by preferentially adopting one of the exposure time of the imaging element and the driving current of the light emitting element from among the sensitivity adjustment parameters, and may increase the gain of the imaging element in a case where the luminance of the difference image does not approach the target luminance even if the one of the exposure time of the imaging element and the driving current of the light emitting element is increased.

In one or more embodiments of the disclosure, the luminance detector may detect, as the luminance of the first image, luminance of a specific region where a specific part of the subject is located, in a region of the first image.

In one or more embodiments of the disclosure, in a case where the specific part of the subject is not found in the specific region, the luminance detector may gradually extend a search range for the specific part on the first image. In a case where the specific part is found within the search range, the luminance detector may newly set a specific region for the specific part and may detect luminance of the specific region which is newly set as the luminance of the first image.

In one or more embodiments of the disclosure, the subject may be a driver of a vehicle, the specific part may be a face of the driver, and the specific region may be a face region where the face is located.

According to the disclosure, it is possible to provide an imaging device capable of adjusting a difference image to optimal brightness according to the level of ambient light.

### BRIEF DESCRIPTION OF THE DRAWINGS

FIG. 1 is an electrical block diagram of a driver monitor according to one or more embodiments of the disclosure;

FIG. 2 is a view illustrating a state in which an imaging unit captures an image of a face;

FIGS. 3A to 3C are views schematically illustrating an off image, an on image, and a difference image, respectively;

FIGS. 4A to 4D are views illustrating a change in face position in an off image and face search ranges;

FIG. 5 is a diagram illustrating an ambient light level table;

FIG. 6 is a diagram illustrating a sensitivity level table; and

FIG. 7 is a flowchart illustrating sensitivity adjustment procedures.

### DETAILED DESCRIPTION

Hereinafter, embodiments of the disclosure will be described with reference to the drawings. In the drawings, identical or corresponding parts are denoted by identical reference signs. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention. Hereinafter, an example in which the disclosure is applied to a driver monitor mounted on a vehicle will be described.

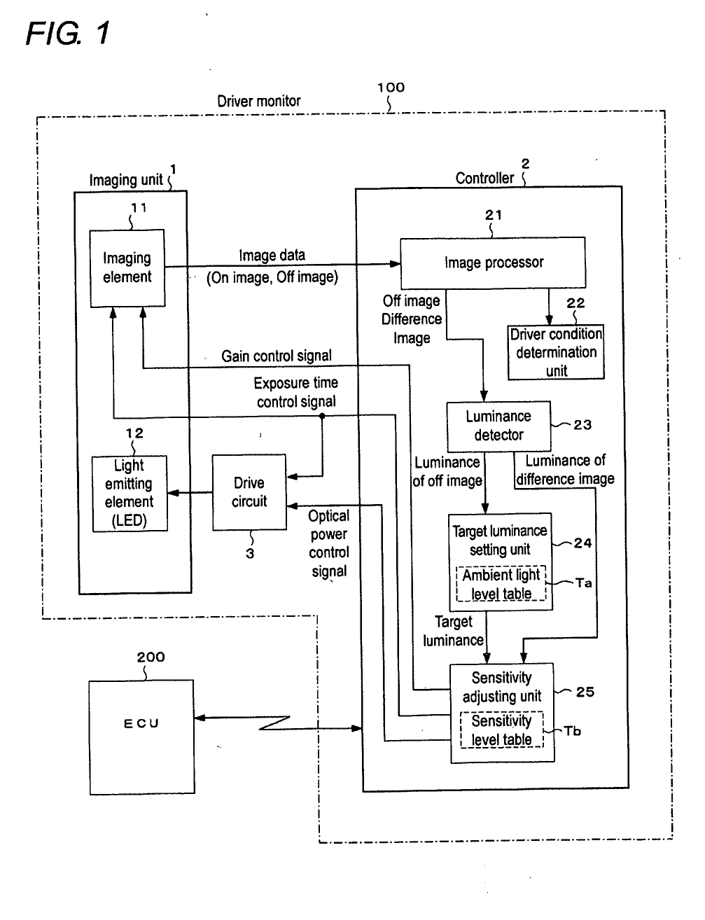

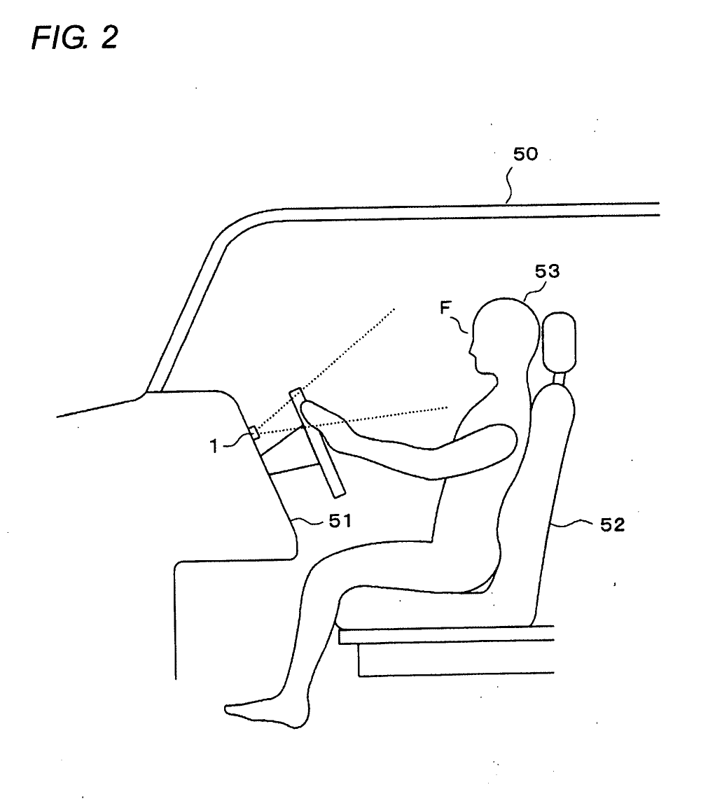

First, with reference to FIGS. 1 and 2, a configuration of the driver monitor will be described. In FIG. 1, the driver monitor 100 is mounted on a vehicle 50 in FIG. 2 and includes an imaging unit 1, a controller 2, and a drive circuit 3.

The imaging unit 1 constitutes a camera, and includes an imaging element 11 and a light emitting element 12. The imaging unit 1 also includes optical component such as a lens (not illustrated) in addition to the imaging element 11 and the light emitting element 12. The imaging element 11 is configured of, for example, a CMOS image sensor. The light emitting element 12 is configured of, for example, an LED that emits near-infrared light.

As illustrated in FIG. 2, the imaging unit 1 is installed at a location facing a face F of a driver 53 seated on a seat 52. Dotted lines indicate the imaging range of the imaging unit 1. In this example, the imaging unit 1 is provided on a dashboard 51 of the driver's seat together with a display and instruments, not illustrated. However, the installation location of the imaging unit 1 is not limited to this. The imaging element 11 captures an image of the face F of the driver 53, and the light emitting element 12 emits near-infrared light to the face of the driver 53. The driver 53 is an example of a “subject” in one or more embodiments of the disclosure.

The imaging unit 1 creates an image (hereinafter referred to as an “off image”) of the driver 53 captured in a state where the light emitting element 12 does not emit light (non light-emitting state) and a second image (hereinafter referred to as an “on image”) of the driver 53 captured in a state where the light emitting element 12 emits light (light emitting state). The imaging unit 1 outputs image, data of the respective images to an image processor 21 of the controller 2.

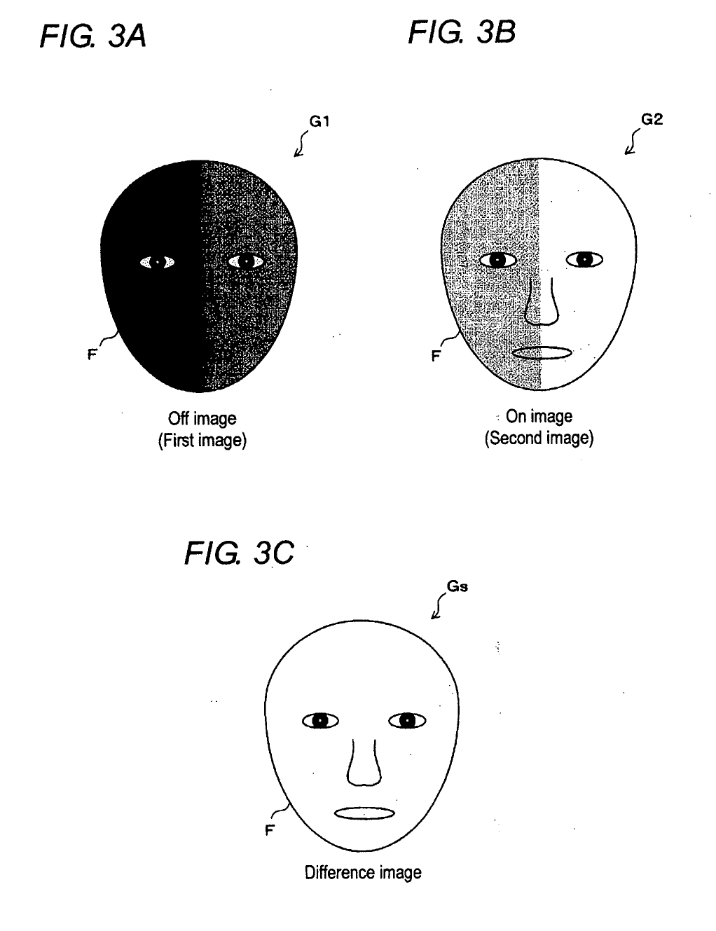

FIG. 3A schematically illustrates an example of the off image. FIG. 3B schematically illustrates an example of the on image. Note that in FIGS. 3A to 3C, images of the background other than the face F are omitted. The off image G1 captured in the state where light is not emitted is darker than the on image G2 captured in the state where light is emitted. The off image G1 corresponds to a “first image” in one or more embodiments of the disclosure, and the on image G2 corresponds to a “second image” in one or more embodiments of the disclosure.

The controller 2 includes the image processor 21, a driver condition determination unit 22, a luminance detector 23, a target luminance setting unit 24, and a sensitivity adjusting unit 25.

The image processor 21 performs predetermined processing on a captured image captured by the imaging unit 1. For example, the image processor 21 creates a difference image which is difference between the on image and the off image obtained from the imaging unit 1. According to the difference image, the image processor 21 detects the face F, feature points of the face (eyes, nose, mouth, and the like) of the driver 53, detects the direction of the face F, and detects the sight line direction.

FIG. 3C schematically illustrates an example of the difference image. Ambient light is removed from the difference image Gs, which is difference between the on image G2 of FIG. 3B and the off image G1 of FIG. 3A. Therefore, the difference image Gs is a clear image with less luminance unevenness.

According to the feature points of the face, the direction of the face, the sight line direction, and the like detected by the image processor 21, the driver condition determination unit 22 determines the driving condition (dozing driving, inattentive driving, and the like) of the driver 53. This determination result is sent to an ECU (Electronic Control Unit) 200, which is a host device. The ECU 200 is mounted on the vehicle 50 and is connected to the driver monitor 100 via a CAN (Controller Area Network), not illustrated.

The luminance detector 23 detects luminance of the off image G1 and luminance of the difference image Gs. Since the off image G1 is captured in a state where light is not emitted, the luminance is low as illustrated in FIG. 3A. In contrast, since the difference image Gs is the difference between the on image G2 which is bright and the off image G1 which is dark, the luminance is high as illustrated in FIG. 3C.

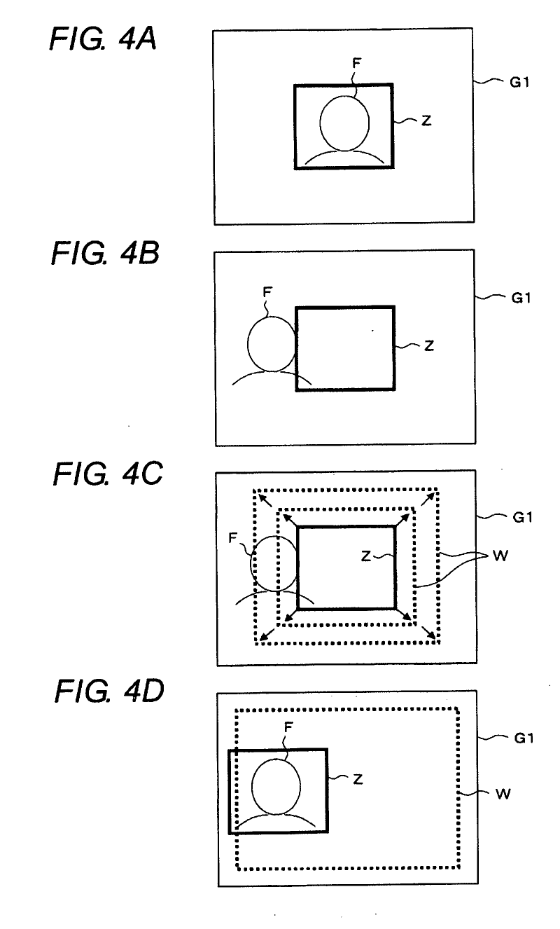

Note that as illustrated in FIG. 4A, the luminance detector 23 detects luminance of a face region Z in which the face F is located, in the region of the off image G1, and sets the luminance as luminance of the off image G1. Upon detecting the luminance of the face region Z, for example, the maximum value or the average value of luminance values of the respective pixels included in the face region Z is obtained, and the maximum value or the average value is set as the luminance of the face region Z. The face region Z may be set in advance in the central region of the off image G1 or may be set every time by using, as a reference, the location where the face F is actually detected in the off image G1. The face region Z is an example of a “specific region” in one or more embodiments of the disclosure. In addition, regarding the difference image Gs, the luminance detector 23 also detects luminance of the face region in a manner similar to the manner described above, and sets the luminance as luminance of the difference image Gs.

In addition, as illustrated in FIG. 4B, in a case where the subject (driver 53) moves and the face F cannot be found in the face region Z, the luminance detector 23 gradually extends a search range W of the face F on the off image G1 as illustrated in FIG. 4C. Then, as illustrated in FIG. 4D, if the face F is found within the search range W, the luminance detector 23 newly sets a face region Z for the face F in this location, and detects luminance of the face region Z which is newly set as luminance of the off image G1. The reason why the search range W is not expanded at once to the entire region of the off image G1 is that there is a risk of erroneous detection due to light from a reflecting object other than the face F if the search range W is expanded at once to the entire region. Regarding the difference image Gs as well, face search is performed in a manner similar to the manner described above.

The target luminance setting unit 24 sets the target luminance of the difference image Gs according to luminance of the off image G1 detected by the luminance detector 23. Since the off image G1 is an image in a state where the light emitting element 12 does not emit light, the luminance of the off image G1 is determined only by ambient light such as sunlight. Therefore, the level of the ambient light can be determined from the luminance of the off image G1 and the target luminance of the difference image Gs can be set according to the level of the ambient light. Setting of the target luminance will be described later in detail.

The sensitivity adjusting unit 25 adjusts the imaging sensitivity of the imaging unit 1 so that the luminance of the difference image Gs detected by the luminance detector 23 approaches the target luminance set by the target luminance setting unit 24. That is, in a case where the luminance of the difference image Gs is lower than the target luminance, the sensitivity adjusting unit 25 increases the imaging sensitivity so as to increase the luminance of the difference image Gs, and in a case where the luminance of the difference image Gs exceeds the target luminance, the sensitivity adjusting unit 25 lowers the imaging sensitivity so as to reduce the luminance of the difference image Gs. This imaging sensitivity adjustment will also be described later in detail.

The drive circuit 3 supplies a predetermined driving current to the light emitting element 12 according an exposure time control signal and an optical power control signal, and causes the light emitting element 12 to emit light. The exposure time control signal and the optical power control signal are given from the sensitivity adjusting unit 25 and will be described later.

Note that in FIG. 1, even though the function of each of the image processor 21, the driver condition determination unit 22, the luminance detector 23, the target luminance setting unit 24, and the sensitivity adjusting unit 25 that the controller 2 includes is actually realized by software, the function is illustrated by a hardware block diagram for the sake of convenience in FIG. 1.

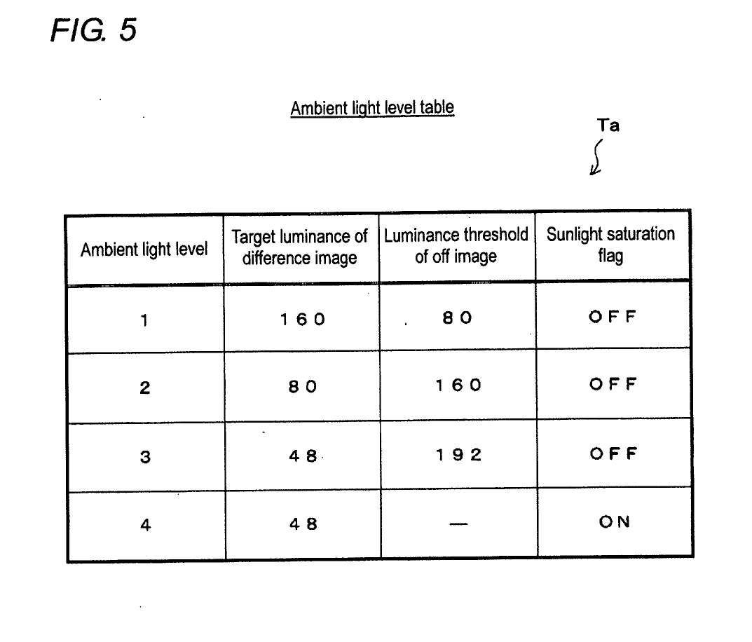

Next, the setting of the target luminance of the difference image Gs in the target luminance setting unit 24 will be described in detail. As illustrated in FIG. 1, the target luminance setting unit 24 is provided with an ambient light level table Ta. A specific example of the ambient light level table Ta is illustrated in FIG. 5. In FIG. 5, the ambient light level table Ta stores ambient light levels at a plurality of stages (here, four stages) corresponding to the luminance of the off image G1, the target luminance of the difference image Gs corresponding to each of the ambient light levels, luminance thresholds of the off image G1, and sunlight saturation flags corresponding to the ambient light levels, respectively. The ambient light level table Ta corresponds to a “first table” in one or more embodiments of the disclosure.

The target luminance setting unit 24 refers to the ambient light level table Ta with respect to the luminance of the off image G1 (hereinafter referred to as “detected luminance X”) detected by the luminance detector 23, and sets the target luminance of the difference image Gs. Specifically, the detected luminance X is compared with the luminance thresholds (80, 160, 192) to determine the ambient light level (levels 1 to 4), and the target luminance (160, 80, 48) corresponding to the ambient light level which is determined is set as the target luminance of the difference image Gs.

For example, if the detected luminance X is X≤80, the ambient light level is 1 and the target luminance is set to 160. If the detected luminance X is 80<X≤160, the ambient light level is 2 and the target luminance is set to 80. If the detected luminance X is 160<X≤192, the ambient light level is 3 and the target luminance is set to 48. In these cases, the sunlight saturation flag is off. In addition, if the detected luminance X becomes 192<X, the ambient light level is 4 and the detected luminance X is saturated. Therefore, the target luminance remains unchanged at 48. In this case, the sunlight saturation flag is turned on, and the controller 2 notifies the ECU 200 that the detected luminance X is saturated due to sunlight which is ambient light.

As described above, in a case where the detected luminance X of the off image G1 is low, the ambient light level is low, that is, the amount of ambient light is small. Therefore, the target luminance of the difference image Gs is increased so that the difference image Gs becomes bright. In contrast, in a Case where the detected luminance X of the off image G1 is high, the ambient light level is high, that is, the amount of ambient light is great. Therefore, the target luminance of the difference image Gs is reduced so that the difference image Gs does not become too bright. That is, in one or more embodiments of the disclosure, the ambient light level is determined from the luminance of the off image G1, and the target luminance according to the ambient light level is set.

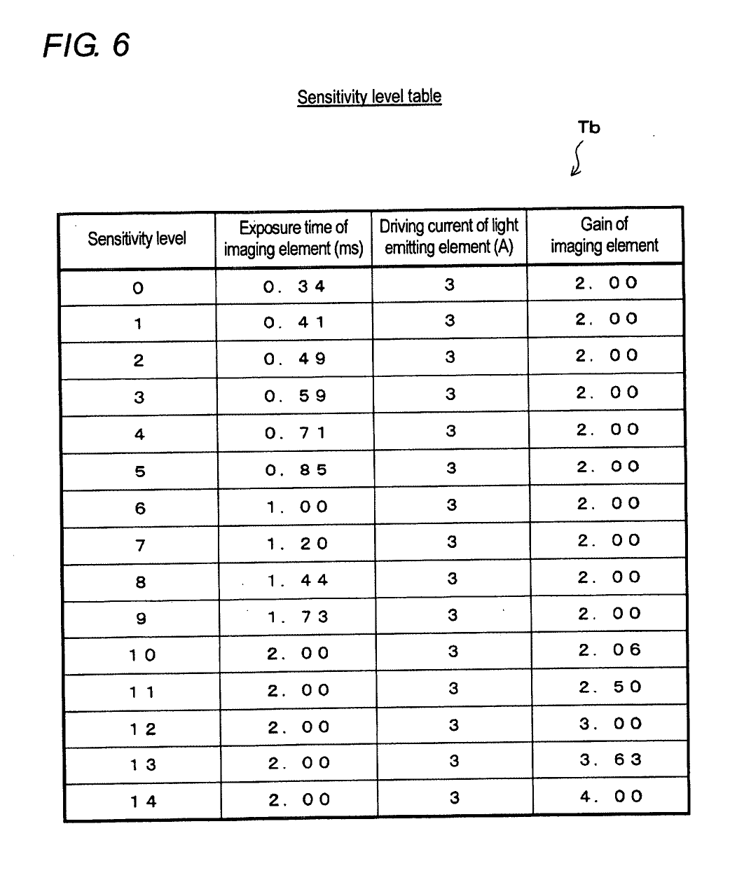

Next, the imaging sensitivity adjustment in the sensitivity adjusting unit 25 will be described in detail. As illustrated in FIG. 1, the sensitivity adjusting unit 25 is provided with the sensitivity level table Tb. A specific example of the sensitivity level table Tb is illustrated in FIG. 6. In FIG. 6, the sensitivity level table Tb stores sensitivity levels at a plurality of stages (here, 15 stages) corresponding to the imaging sensitivity of the imaging unit 1 and sensitivity adjustment parameters corresponding to the sensitivity levels, respectively. In this example, the sensitivity adjustment parameters are configured of exposure time of the imaging element 11, a driving current of the light emitting element 12, and a gain of the imaging element 11. The sensitivity level table Tb corresponds to a “second table” in one or more embodiments of the disclosure.

In the example of FIG. 6, the exposure time of the imaging element 11 increases as the sensitivity level increases and becomes constant when the sensitivity level reaches sensitivity level 10. The driving current of the light emitting element 12 is constant over all sensitivity levels 0 to 14. The gain of the imaging element 11 is constant up to sensitivity level 9 and increases as the sensitivity level increases on and above level 10. Note that in this example, the gain of the imaging element 11 is an analog gain.

The exposure time of the imaging element 11 is controlled by the exposure time control signal output from the sensitivity adjusting unit 25. The driving current of the light emitting element 12 is controlled by the optical power control signal output from the sensitivity adjusting unit 25. The gain of the imaging element 11 is controlled by a gain control signal output from the sensitivity adjusting unit 25. In addition, energizing time of the driving current of the light emitting element 12 is controlled by the exposure time control signal output from the sensitivity adjusting unit 25, and the light emitting element 12 is energized and emits light for only the period of exposure time.

The sensitivity adjusting unit 25 compares the luminance (hereinafter referred to as “detected luminance Y”) of the difference image Gs detected by the luminance detector 23 with the target luminance set by the target luminance setting unit 24, and changes the sensitivity level so that the detected luminance Y is within the range oft a of the target luminance, that is, so that the detected luminance Y approaches the target luminance. Note that a is a constant value set in advance.

For example, in FIG. 5, assume that the target luminance of the difference image Gs is set to 80 (ambient light level: 2), and the sensitivity level at this time is level 7 in FIG. 6. In this case, if the detected luminance Y is Y<80−α, that is, if the detected luminance Y is lower than the target luminance by a predetermined amount, the sensitivity level is raised to level 8. As a result, the exposure time of the imaging element 11 is changed from 1.20 sec to 1.44 sec, and the exposure time is extended. Therefore, the imaging sensitivity increases and the luminance of the difference image Gs increases.

After raising the sensitivity level to level 8, the sensitivity adjusting unit 25 checks the detected luminance Y of the difference image Gs detected by the luminance detector 23. Then, if the detected luminance Y still remains Y<80−α even though the sensitivity level is raised to level 8, the sensitivity level is raised to level 9. As a result, the exposure time of the imaging element 11 is changed from 1.44 sec to 1.73 sec, and the exposure time is further extended. Therefore, the imaging sensitivity further increases and the luminance of the difference image Gs further increases. However, if the detected luminance Y still remains Y<80−α even though the sensitivity level is raised to level 9, the sensitivity adjusting unit 25 raises the sensitivity level to level 10. Thereafter, similarly, the sensitivity level is raised stepwise until the detected luminance Y becomes Y≥80−α.

Note that at level 10, the exposure time of the imaging element 11 is changed from 1.73 sec to 2.00 sec, and at the same time, the gain of the imaging element 11 is also changed from 2.00, which is the previous value, to 2.06. This is because in a case where it is difficult to bring the detected luminance Y close to the target luminance only by changing the exposure time, the imaging sensitivity is further increased and the detected luminance Y is quickly brought close to the target luminance by increasing the gain of the imaging element 11. In addition, the reason why the gain is not increased until the sensitivity level reaches level 10 is that noise in the captured image is increased by increasing the gain.

In one or more embodiments of the disclosure, upon increasing the imaging sensitivity, the exposure time of the imaging element 11 among the sensitivity adjustment parameters is preferentially adopted. Then, increasing the imaging sensitivity is coped with by changing the exposure time as long as possible. At the time when it becomes impossible to cope with increasing the imaging sensitivity by the exposure time, noise in a captured image is minimized by increasing the gain of the imaging element 11.

The above describes a case where the sensitivity level is raised stepwise. However, lowering the sensitivity level stepwise is similar.

For example, in FIG. 5, assume that the target luminance of the difference image Gs is set to 48 (ambient light level: 3), and the sensitivity level at this time is level 9 in FIG. 6. In this case, if the detected luminance Y is Y>48+α, that is, if the detected luminance Y exceeds the target luminance by the predetermined amount, the sensitivity level is lowered to level 8. As a result, the exposure time of the imaging element 11 is changed from 1.73 sec to 1.44 sec and the exposure time is shortened. Therefore, the imaging sensitivity decreases and the luminance of the difference image Gs is reduced.

After lowering the sensitivity level to level 8, the sensitivity adjusting unit 25 checks the detected luminance Y of the difference image Gs detected by the luminance detector 23. Then, if the detected luminance Y still remains Y>48+α even though the sensitivity level is lowered to level 8, the sensitivity level is lowered to level 7. As a result, the exposure time of the imaging element 11 is changed from 1.44 sec to 1.20 sec, and the exposure time is further shortened. Therefore, the imaging sensitivity is further lowered and the luminance of the difference image Gs is further reduced. Thereafter, similarly, the sensitivity level is lowered stepwise until the detected luminance Y becomes Y≤48+α.

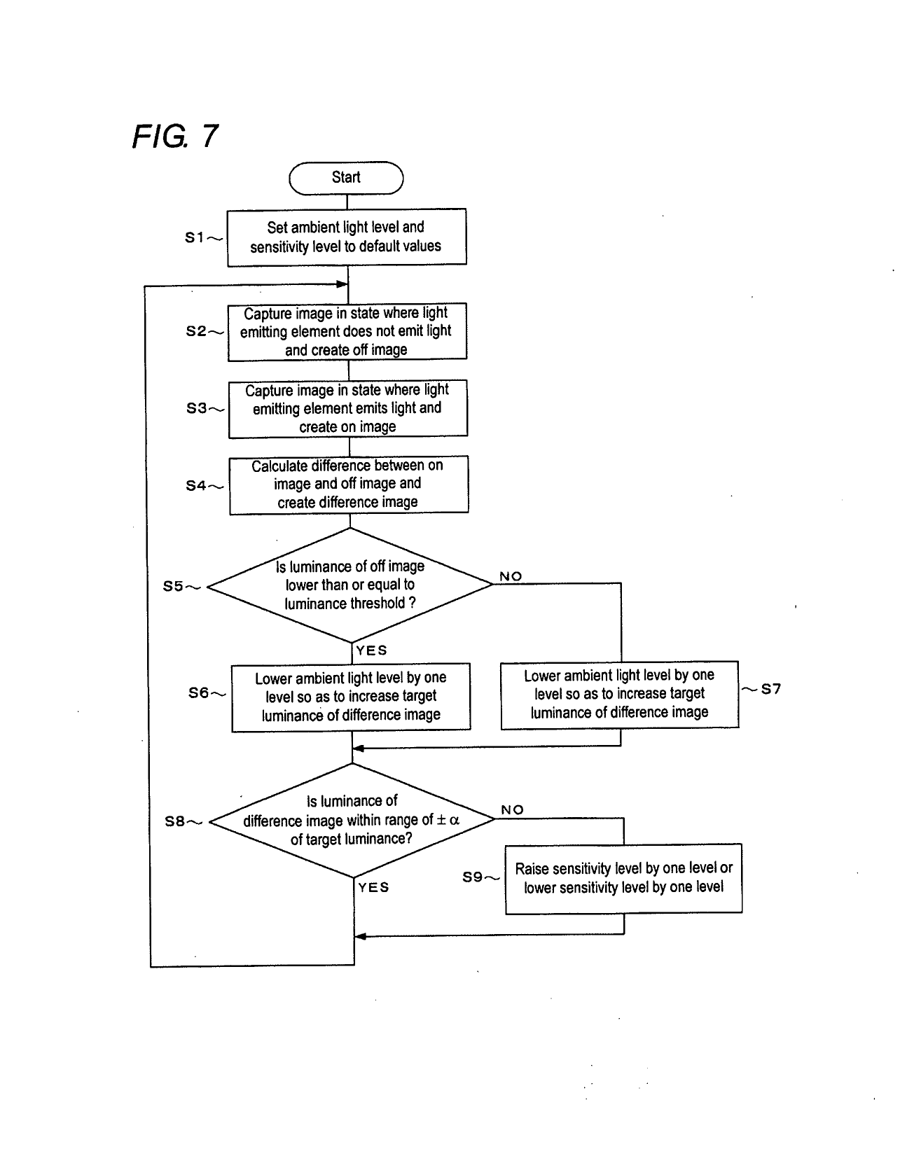

FIG. 7 is a flowchart illustrating a series of sensitivity adjustment procedures.

In FIG. 7, in step S1, the target luminance setting unit 24 sets the ambient light level to a default value (for example, level 2), and the sensitivity adjusting unit 25 sets the sensitivity level to a default value (for example, level 9).

In step S2, in a state where the light emitting element 12 does not emit light, the imaging unit 1 captures an image of the driver 53 and creates an off image G1. In step S3, in a state where the light emitting element 12 emits light, the imaging unit 1 captures an image of the driver 53 and creates an on image G2. In step S4, the image processor 21 calculates difference between the on image G2 and the off image G1 and creates a difference image Gs.

In step S5, the target luminance setting unit 24 determines whether or not luminance (detected luminance X described above) of the off image G1 detected by the luminance detector 23 is lower than or equal to the luminance threshold in the ambient light level table Ta in FIG. 5. As a result of the determination, if the luminance of the off image G1 is lower than or equal to the luminance threshold (step S5: YES), the process proceeds to step S6. In step S6, the target luminance setting unit 24 lowers the ambient light level in the ambient light level table Ta by one level and increases the target luminance of the difference image Gs.

In contrast, as a result of the determination in step S5, if the luminance of the off image G1 is not lower than or equal to the luminance threshold (step S5: NO), the process proceeds to step S7. In step S7, the target luminance setting unit 24 increases the ambient light level in the ambient light level table Ta by one level and lowers the target luminance of the difference image Gs.

After steps S6 and S7 are executed, the process proceeds to step S8. In step S8, the sensitivity adjusting unit 25 determines whether or not the luminance (detected luminance Y described above) of the difference image Gs detected by the luminance detector 23 is within the range oft a of the target luminance. As a result of the determination, if the luminance of the difference image Gs is within the range of ±α of the target luminance (step S8: YES), the process returns to step S2 and the imaging unit 1 continues capturing an image. In contrast, as a result of the determination, if the luminance of the difference image Gs is not within the range of ±α of the target luminance (step S8: NO), the process proceeds to step S9.

In step S9, the sensitivity adjusting unit 25 changes the sensitivity level in the sensitivity level table Tb. In this case, if the detected luminance Y of the difference image Gs is Y<target luminance−α, that is, the target luminance is lower than the target luminance by the predetermined amount, the sensitivity level is raised by one level to increase the imaging sensitivity. In addition, if the detected luminance Y of the difference image Gs is Y>target luminance+α, that is, the detected luminance exceeds the target luminance by the predetermined amount, the sensitivity level is lowered by one level to decrease the imaging sensitivity. After step S9 is executed, the process returns to step S2 and the imaging unit 1 continues capturing an image.

In one or more embodiments of the disclosure, luminance of the off image G1 and luminance of the difference image Gs are detected, the target luminance of the difference image Gs is set according to the luminance of the off image G1, and the imaging sensitivity of the imaging unit 1 is adjusted such that the luminance of the difference image Gs approaches the target luminance. Therefore, the level of ambient light can be determined from luminance of the off image G1, and the target luminance of the difference image Gs can be set to a value corresponding to the level of the ambient light. As a result, it is possible to adjust the difference image to optimal brightness by setting the target luminance to be low in a case where the amount of ambient light is great and by setting the target luminance to be high in a case where the amount of ambient light is small.

In one or more embodiments of the disclosure, in addition to an illustrative embodiment, various embodiments described below can be adopted.

In an illustrative embodiment, in the sensitivity level table Tb of FIG. 6, the driving current of the light emitting element 12 is constant irrespective of the sensitivity level. However, the driving current of the light emitting element 12 may be increased as sensitivity level increases.

In an illustrative embodiment, in the sensitivity level table Tb of FIG. 6, the exposure time of the imaging element 11 is prioritized among the sensitivity adjustment parameters. However, driving current of the light emitting element 12 may be prioritized.

In an illustrative embodiment, in the sensitivity level table Tb of FIG. 6, three parameters, that is, the exposure time, the driving current, and the gain are used as the sensitivity adjustment parameters. However, sensitivity adjustment parameters may be two or one of them.

In an illustrative embodiment, the analog gain is adopted as the gain of the imaging element 11. However, a digital gain may be adopted. In addition, an analog gain and a digital gain may be used together.

In an illustrative embodiment, it is determined whether or not the luminance of the difference image Gs is within the range of ±α of the target luminance in step S8 in FIG. 7. However, it may be determined whether or not luminance of a difference image Gs is equal to target luminance. That is, the value of a may be zero.

In an illustrative embodiment, an example in which the face region Z in the captured image is a quadrangle has been described (FIG. 4). However, the disclosure is not limited to this, and a face region Z may be a rhomboid, an ellipse, a circle, or the like.

In an illustrative embodiment, the subject is the driver 53 of the vehicle, the specific part of the subject is the face F, and the specific region in the captured image is the face region Z. However, the disclosure is not limited to them. A subject may be an occupant other than a driver, a specific part of the subject may be a part other than a face, and a specific region may be a region in which a part other than the face is located.

In an illustrative embodiment, the driver monitor 100 mounted on the vehicle is described as an example of the imaging device of the disclosure. However, the disclosure can also be applied to an imaging device used for a purpose other than as a vehicle.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An imaging device comprising:
an imaging unit including an imaging element configured to capture an image of a subject and a light emitting element configured to emit light to the subject; and
an image processor configured to perform predetermined processing on a captured image captured by the imaging unit,
the imaging unit configured to create a first image of the subject captured in a state where the light emitting element does not emit light and a second image of the subject captured in a state where the light emitting element emits light, and
the image processor configured to create a difference image which is difference between the first image and the second image and to detect the subject according to the difference image,
the imaging device further comprising:
a luminance detector configured to detect luminance of the first image and luminance of the difference image;
a target luminance setting unit configured to set target luminance of the difference image according to the luminance of the first image detected by the luminance detector; and
a sensitivity adjusting unit configured to adjust imaging sensitivity of the imaging unit such that the luminance of the difference image detected by the luminance detector approaches the target luminance set by the target luminance setting unit.

2. The imaging device according to claim 1,
wherein the target luminance setting unit compares the luminance of the first image detected by the luminance detector with a luminance threshold set in advance,
wherein in a case where the luminance of the first image is not greater than the luminance threshold, the target luminance of the difference image is increased, and
wherein in a case where the luminance of the first image is greater than the luminance threshold, the target luminance of the difference image is reduced.

3. The imaging device according to claim 1,
wherein the sensitivity adjusting unit increases the imaging sensitivity in a case where luminance of the difference image detected by the luminance detector is lower than the target luminance by a predetermined amount, and
wherein the sensitivity adjusting unit decreases the imaging sensitivity in a case where luminance of the difference image detected by the luminance detector exceeds the target luminance by a predetermined amount.

4. The imaging device according to claim 1,
wherein the target luminance setting unit has a first table storing ambient light levels at a plurality of stages according to the luminance of the first image and the target luminance corresponding to each of the ambient light levels, and
wherein the target luminance setting unit sets, with reference to the first table, the target luminance for the luminance of the first image detected by the luminance detector.

5. The imaging device according to claim 1,
wherein the sensitivity adjusting unit has a second table storing sensitivity levels at a plurality of stages according to the imaging sensitivity of the imaging unit and sensitivity adjustment parameters corresponding to the sensitivity levels, respectively, and
wherein the sensitivity adjusting unit adjusts the imaging sensitivity according to the sensitivity adjustment parameters with reference to the second table, with respect to the target luminance of the difference image set by the target luminance setting unit.

6. The imaging device according to claim 5,
wherein the sensitivity adjustment parameters include at least one of exposure time of the imaging element, a driving current of the light emitting element, and a gain of the imaging element.

7. The imaging device according to claim 6,
wherein the sensitivity adjusting unit adjusts the imaging sensitivity by preferentially adopting one of the exposure time of the imaging element and the driving current of the light emitting element from among the sensitivity adjustment parameters, and
wherein the sensitivity adjusting unit increases the gain of the imaging element in a case where the luminance of the difference image does not approach the target luminance even if the one of the exposure time of the imaging element and the driving current of the light emitting element is increased.

8. The imaging device according to claim 1,
wherein the luminance detector detects, as the luminance of the first image, luminance of a specific region where a specific part of the subject is located, in a region of the first image.

9. The imaging device according to claim 8,
wherein in a case where the specific part of the subject is not found in the specific region, the luminance detector gradually extends a search range for the specific part on the first image, and if the specific part is found within the search range, the luminance detector newly sets a specific region for the specific part which is found and detects luminance of the specific region which is newly set, as the luminance of the first image.

10. The imaging device according to claim 8,
wherein the subject is a driver of a vehicle,
wherein the specific part is a face of the driver, and
wherein the specific region is a face region where the face is located.
